(19) United States
(12) Patent Application Publication
(10) Pub. No.: US 2008/0235116 A1
(43) Pub. Date: Sep. 25, 2008

(54) PROCESS AND METHOD FOR SYSTEMATICALLY EXCHANGING PRODUCT BETWEEN MANUFACTURER OF PRODUCT OR REPRESENTATIVE OF PRODUCT AND PURCHASER FOR AN ESTABLISHED TERM

(76) Inventor: John B. Jensen, Windsor, CO (US)

Correspondence Address: COCHRAN FREUND & YOUNG LLC, 2026 CARIBOU DR, SUITE 201, FORT COLLINS, CO, 80525, US

(21) Appl. No.: 11/689,797

(22) Filed: Mar. 22, 2007

(51) Int. Cl. G06Q 10/00; G06Q 90/00

(52) U.S. Cl. 705/28

(57) ABSTRACT

There is provided by this invention a process that obligates and joins manufacturers and or distribution outlets with customers for a predetermined fee to provide and allow purchasers to exchange purchased products after a predetermined time for a new product. Manufacturers and or outlets assume responsibility to sell or if chosen re-exchange the returned product. The products may be the type that depreciates with age and use, such as automobiles, boats, recreational vehicles, equipment, machinery, etc. Manufacturer and or outlet provides product at the established value level to the customer for a certain length of time. Customer uses the product for a determined length of time, for example one year, then returns and exchanges said product each year for new product throughout the term of the agreement, allowing customer to maintain new status and factory warranty and eliminating the hassles of selling the product. Manufacturer and or outlet markets and sells or begins another exchange process with returned product to a second customer through outlets and community database web sites.

### CROSS REFERENCE TO RELATED APPLICATIONS

This application is based upon and claims priority to U.S. provisional application Ser. No. 60/742,833, filed Mar. 28, 2006, by John Jensen, entitled “Process and Method for Systematically Exchanging Product Between Manufacturer of Product and or Representative of Product and Customer for an Established Term Referred to as Product Exchange Process,” which is specifically incorporated by reference herein for all that it discloses and teaches.

### BACKGROUND OF THE INVENTION

1. Field of the Invention

This invention relates generally to a process that combines the manufacturer of products or distribution outlets in a long term relationship with purchaser, and more particularly to a process obligating manufacturers or distribution outlets to exchange new or certain used products with a purchaser on an annual basis for a specified term.

2. Brief Description of the Related Art

In typical transactions in the sale of products, a manufacturer produces the product and distributes it to outlets which then market products to potential customers. Potential customers then go to the sales outlet and negotiate for purchasing the product. If a customer decides to purchase the product, payment is then arranged by either financing or by paying cash. Another alternative would be to lease the product and make payments similar to financing. As the product is used, it, in most cases, changes ownership throughout the life of the product and its value diminishes accordingly.

For the manufacturer, projecting materials for manufacturing products is very difficult and is based on forecasting for the future of hopeful sales. Like many things, ordering too much material and not using it in a timely manner adds additional expenses and costs, or material could become outdated. Not ordering enough for demand means missing potential sales or reordering becomes necessary and prices of materials increase, in turn increasing the price of the product. Producing an abundance of product can overload sales outlets, where not producing enough makes sales outlets miss out on potential sales. Either way it can become costly.

For sales outlets, estimating sales and ordering in advance is necessary because of the time it takes to produce the product. Most commonly, sales outlets project yearly sales and order product to meet said projections. The problem for outlets is if projections are high, sales outlets will carry too much product which results in costly fees and selling at discounts to eliminate excess product. It is difficult for outlets to guess how customers will outfit product to their wants, needs and budget. It is also very difficult for sales outlets and or manufacturers to maintain a long term relationship with customers, keeping them returning to their facilities and maintaining loyalty. Once a customer completes the purchase of said product, reasons for the customer to return to the outlet subside the longer they own the product.

For the customer, the process of purchasing said product can be unrewarding and frustrating. Because sales promotions are complicated, it is hard for the customer to determine the costs involved in purchasing the product. Another problem for a customer is that new product typically depreciates as soon as it is purchased and continues to depreciate throughout the ownership of the life of the item. Once the warranty period is up, expensive repairs become a relative part of ownership from age and wear and tear. With repairs and depreciation, this becomes very costly. Another problem is that new product may be too expensive for certain customers, making customers buy used product. With used product comes the chance of costly repairs, because of prior wear and tear, for the customer. If they qualify, customers may be able to finance or lease said product which can substantially add to the cost of the product with finance charges and fees. When a customer decides to change product, it is his or her responsibility to market, sell or trade their product. Many times selling used product can be expensive in terms of depreciation, costly repairs throughout ownership, financing costs if applicable and advertising expense where customer bears all responsibility for these costs. The process of selling is also time consuming and difficult for the customer. Determining fair value is very difficult and trading may not maximize the value of the product.

There are many issues that are present in producing, selling and owning product. The normal process does not allow consumers ability to possess and exchange product without paying the full amount of the price and in most cases faces high depreciation. The above process also does not obligate the manufacturer and or outlet to exchange product and sell returned product to a second customer. Also the above process does not obligate the manufacturer and or the sales outlet to stay involved with the customer after the transaction as time goes on.

Previous methods may disclose utilizing an electronic communication system between the manufacturer, retailer, or potential purchaser to identify articles available for sale to create a virtual exchange network for sale of products as disclosed in U.S. Pat. No. 6,954,734. This patent discloses a virtual internet exchange is utilized for the sale of used goods. It would be desirable if there were provided a method of selling product to purchasers that maintained a contractual relationship between the manufacturer of product and distributor of product with the purchaser that allowed the purchaser to return the product or exchange the product after a predetermined time for a predetermined fee.

### SUMMARY OF THE INVENTION

There is provided by this invention a method of selling product to a purchaser that establishes a contractual relationship between the manufacturer and distributor of the product with the purchaser for a predetermined time period at a predetermined price that allows the purchaser to exchange or return the product for a new product within the predetermined time period. The manufacturer and distributor bear the cost and responsibility of reselling the exchanged product to a second customer who may also enter into an exchange agreement with the manufacturer and distributor.

### BRIEF DESCRIPTION OF THE DRAWINGS

FIG. 1 illustrates a flow chart of the process by which a product is ordered, manufactured and exchanged.

FIG. 2 illustrates a form that may be utilized by a customer to order product.

FIG. 3 illustrates a flow chart of the process for making a returned or potential returned item available for sale to a second customer.

FIG. 4 illustrates a database for product that has or will be exchanged and will be for sale to a secondary customer.

FIG. 5 illustrates a flow chart of the process by which a second customer enters into an exchange agreement on product from the first customer, if an exchange program is offered on returned product.

### BRIEF DESCRIPTION OF THE PREFERRED EMBODIMENT

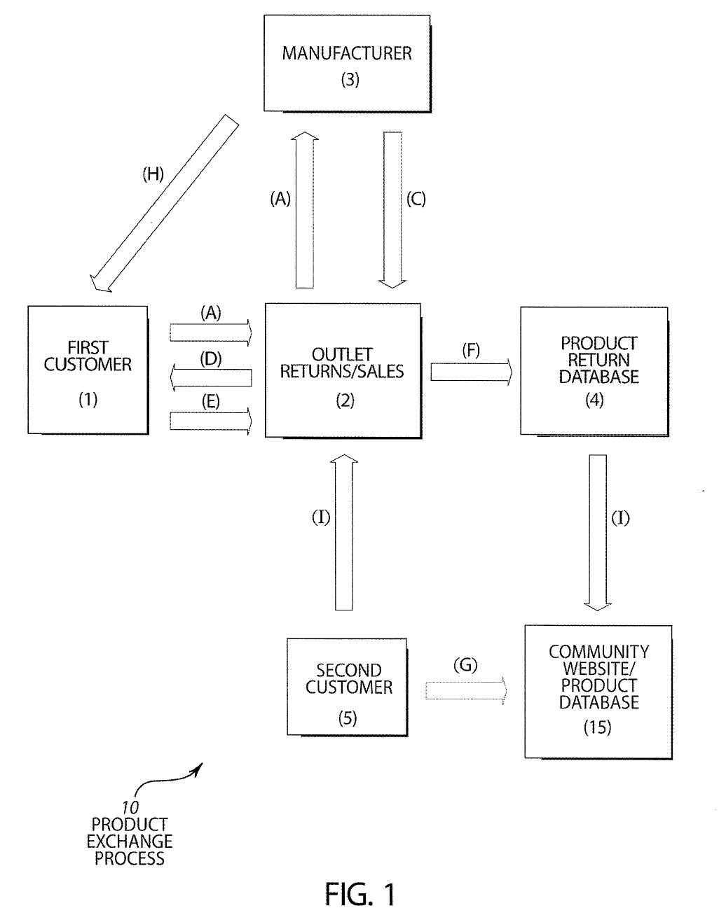

Referring to FIG. 1, there is shown a flow chart 10 of the process by which product will be exchanged. The product may be items that depreciate with age and use such as automobiles, boats, recreational vehicles, machinery, equipment, etc. At line A, the first customer (1) orders product or picks from available product from a distribution outlet (2). If outlet (2) has available in stock, the product with the options first customer (1) desires, then customer may choose that one. If, first customer (1) orders the product, it is done with outlet (2). At line B, the outlet (2) places an order with manufacturer (3). Manufacturer (3) produces the product of first customer's (1) choice and at line C delivers the product to outlet (2). Outlet (2) delivers product, line D, to first customer (1). First customer (1) pays a fee to obtain use of the product for a period of 1 year with an agreement to exchange the product for a product of equal value each year. At some predetermined time prior to the date of returning product for exchange, first customer (1) goes to outlet (2) or electronically repeats the beginning steps to exchange the current product for a new product on anniversary date. First customer (1) returns product, line E, to outlet (2) and exchanges the current product for new product that had been ordered or selected earlier. The product that has been returned for exchange will be listed in a product return database (4). The product is also listed on a community website (15) throughout the year because outlet (2) knows it will be available for a second customer (5) to purchase on the exchange date of the product by customer (1). Sales outlet (2) markets exchanged product through product return database (4) shown through line F. Product return database (4) is listed on a community website (15) to second customer (5). Second customer (5) can search the web site (15) for product they are interested in shown through line G. A second customer (5) would purchase and pick up product from outlet (2) shown through line J.

The manufacturer (3) could work directly with first customer (1) and second customer (5) bypassing the outlet (2) using this invention which is shown through line H. However, the disadvantage with this path is not having locations that are convenient for the customers. Utilizing outlet (2) would make it more convenient for the consumer to conduct ongoing relationships. Outlet (2) can provide any necessary warranty work and other important customer service needs.

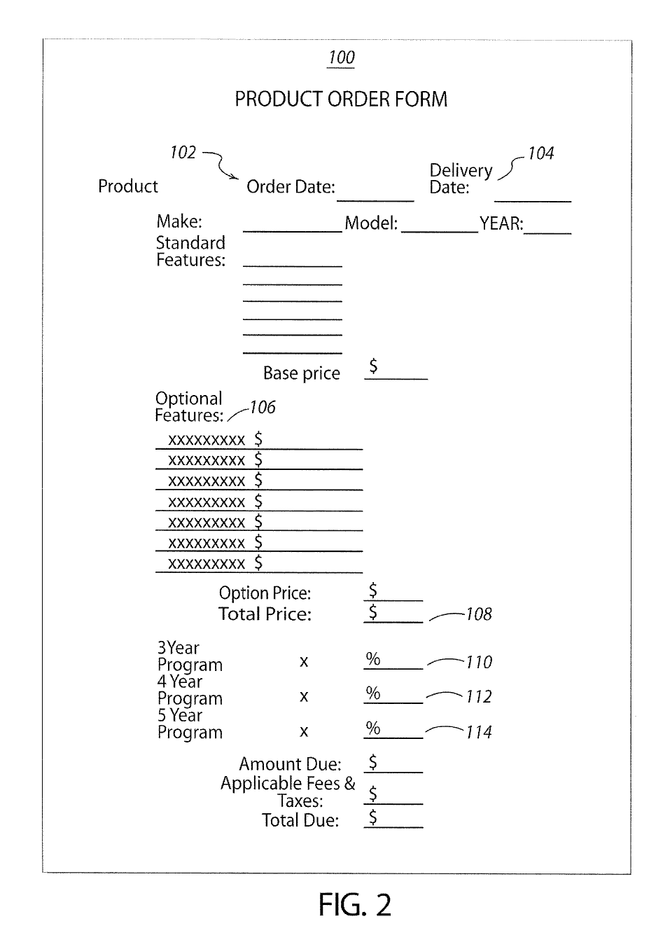

A typical product order form is illustrated in FIG. 2. FIG. 2 depicts a generic product order form (100) on which a customer orders new product to begin the process and continues to order throughout the term of the program. The form would list the product make, model, year, standard features and the base price. There are also two dates on the form, order date 102 and delivery date 104. These dates are available to allow the customer to use the order date to order the new product every year for exchange. This should keep the delivery date about the same time each year to exchange product. Also on the form are the options 106 that are available for the product. The customer can choose any of these or none of these. Standard base price along with total options price will give the total price 108. The customer then can choose from one of the plans that are offered, three year 110, four year 112, and five year 114. Each plan will have a percentage fee which is taken on the total price. The percentage that is figured plus applicable taxes and fees is the amount due from the customer.

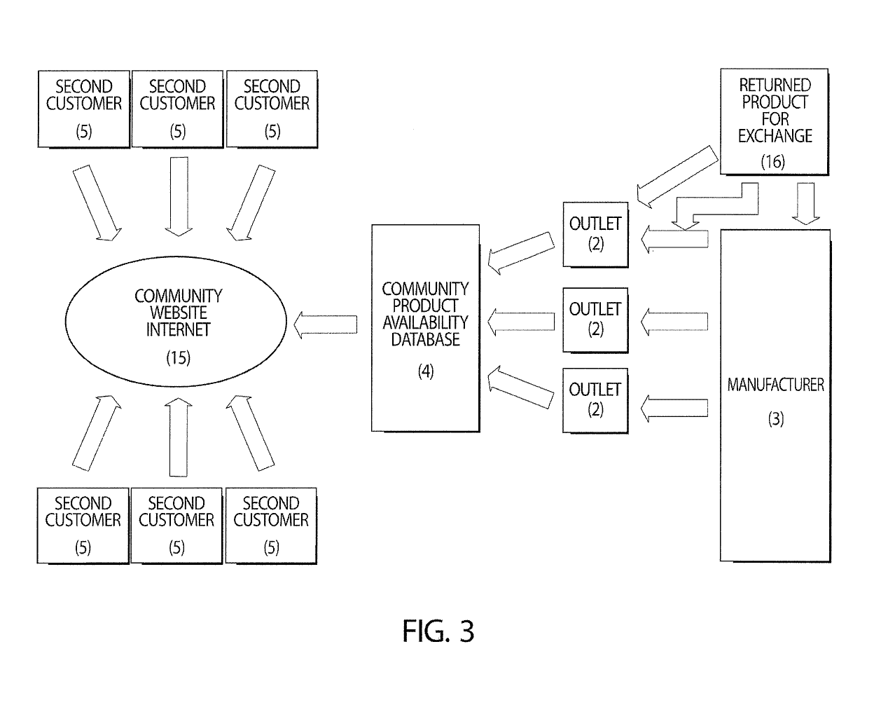

Product that is returned for exchange is shown in FIG. 3. FIG. 3 shows the flow by which a first customer (1) returns product to outlet (2) for exchange. Product has already been listed in a community product availability database (4) prior to product being returned. The product has been available for viewing on a community website (15) to potential second customers (5). With the exchange process, the date the product is delivered to first customer (1), the date the manufacturer (3) or outlet (2) will know when the product will be returned and available for resale is listed in the product availability data base (4) and on the community website (15). The returned product (16) which may be purchased by the second customer (5) is also available for an exchange program.

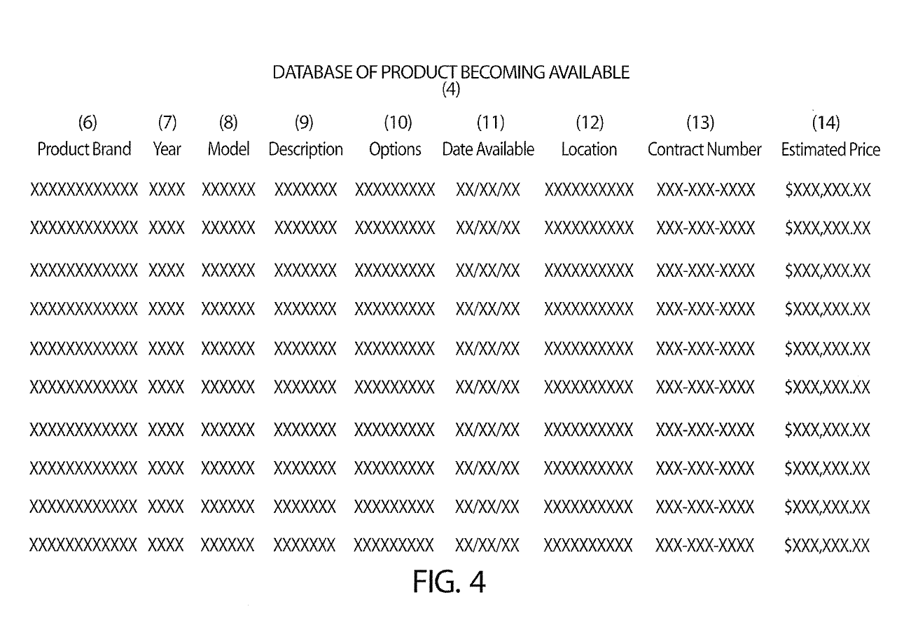

Customers can search by specific categories which are better shown in FIG. 4. Also, customers can visit outlets (2) which will also be able to provide the information. A detail of the database is shown in FIG. 4. FIG. 4 shows descriptions and details of the product that has or will be exchanged and will be for sale to a second customer. This database (4), which can be viewed through an internet web site (15), supplies the second customer (5) with information such as product brand (6), year of the product (7) description of product (9), any options (10), date available (11) what outlet it is being returned to (12), phone number (13) of the outlet (2) and estimated selling price of the product (14). The community website with the information about product that will be returned can also be used if exchange process is available.

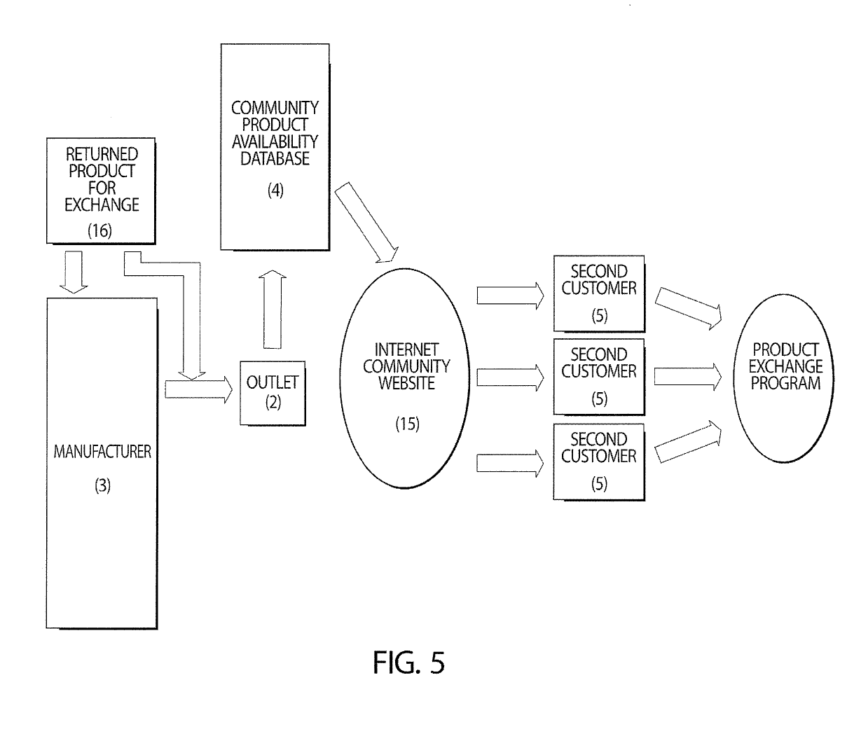

FIG. 5 shows the process if second customer enters into an exchange program on returned product (16). FIG. 5 shows the flow if manufacturer (3) or outlet (2) elects to resell or exchange returned product (16) and if second customer (5) wishes to enter into an exchange program. Manufacturer (3) or outlet (2) would receive returned product (16) and enter into exchange program with a second customer (5). The exchange process would be similar to the original process when the product was new. The difference is the second customer would not be ordering the product, but would choose from product that is being returned. Warranties may or may not be available or may be a little different. If the returned product is re-exchanged, then that product will be marketed and eventually sold to a third customer.

This invention is a straight forward and simple process for all parties involved. Product exchange process allows the first customer to pay one fee that is a portion of the price of the product and not worry about these additional expenses other than general maintenance. Product exchange-process then allows a second customer to purchase the product after it is returned for exchange, avoiding the major depreciation that occurs in the first year of the product, and both only pay taxes on their portion. The second customer may also be able to enter into an exchange process on the returned product.

Another advantage of product exchange process is that it provides the first customer, for a fee, the ability to use and exchange products, such as cars, boats, motorcycles, recreational products, equipment and machinery, etc., on a predetermined time schedule (i.e. annually), maintaining manufacturer's warranty, utilizing changes, upgrades and new status. This process distributes the burden of depreciation and sale of the product among the manufacturer and or sales outlet. Because the ratios and fees are determined on the price, there will not be any need for negotiating. This process allows a second customer to purchase product that has been returned for exchange for fair market value which will be considerably less than the original value, avoiding the first year of high depreciation. This process improves future projections of production of product for the manufacturer and inventory control for the sales outlet.

Another advantage of this invention makes it more affordable for customers to obtain and use new current products, maintaining factory warranty and minimizing repair expenses for the term of the program. Product exchange process will also give people the ability to experience the use of more expensive products for a fee that is a fraction of the price of the product, which would be less than the cost of owning and reselling the product for the first customer. Because the price is figured on fair market value, this invention makes it more affordable to purchase the product that is exchanged for the second customer by avoiding the first year high depreciation. The fees will be formulated to the current prices of the products and the number of years to exchange their product that fits customer needs (i.e. 3, 4, 5, etc.). Product exchange process would typically be based on a yearly exchange but may be altered in situations that may seem fit.

The product exchange process will benefit the first customer because the product in the exchange will be in the warranty period and will keep the individual from paying for anything other than general maintenance and neglect. Major mechanical problems not caused by the consumer will be covered under warranty. Product exchange process will allow individuals to experience more expensive products that may not be affordable in normal purchasing environments, or allow individuals who can only afford used products to experience new status each year for the term.

The product exchange allows consumers to save money on future losses of the product by paying a portion of the price up front that will be less than amount lost when the item is resold after ownership. These people pay a one time fee which is a percentage of the price depending on the length of the program they choose. Taxes are figured on the amount paid only. The remaining taxes will be paid by the secondary consumer on the purchase price. The fee may be able to be put on some type of installment payments. This would have some similarities of a traditional lease except the payments would be figured on the fee portion not the total price of the vehicle. Another difference is the product is exchanged annually for the original fee. Installment payments would be figured on a shorter time frame than the total length of the term.

The advantage for a manufacturer is being able to forecast materials and supplies for production. Knowing what product is committed for and needed for the exchange helps the manufacturers project and negotiate prices on materials needed to produce the product. Being able to commit to materials up front and in bulk helps the manufacturer have consistent and precise prices. Because the fee is a fraction of the price of the product, manufacturers provide an opportunity for customers that may not typically be able to afford new product.

An advantage for an outlet is this invention allows certainty on product that will be exchanged year after year. The hardest thing for retail business is to forecast yearly sales. If the forecast is too low, outlets run out of product and miss potential sales. If the forecast is too high, outlets have inventory that carries over and accumulates charges and does not sell for the original asking price. Outlets/dealers will know what to order for their customers in the exchange year after year and be able to maintain a more efficient projection of product. By providing product exchange process to their customers, outlets are able to provide straight forward fees and eliminate the sometimes long, grueling negotiating of prices. Outlets will also be able to know what product will be exchanged, thus being able to allow a second customer to reserve the product to buy up to a year in advance. Outlets may also decide to take the returned product and begin an exchange with a second customer.

Also with this invention, consumers have the ability to upgrade from exchange to exchange. If the primary consumer wants to upgrade price levels (i.e. primary's original level was $20,000 and primary decides he/she wants something at the $25,000 level), the primary pays the same percentage originally on the increase of $5000 only, plus applicable taxes on that portion. Having a database on the Internet listing product that is going to be exchanged will provide an easy way to market product that will be returned to a second customer. Because manufacturers and/or outlets know in advance product that will be returned for exchange, they will be able to provide this information on a community website for all of the outlets to use, as well as let the second customer throughout the world be able to view these products being returned and know when they are available. This database will give a second customer a wider selection and allows them plenty of time to research and make sound decisions before purchasing said product. With this invention, the history of the product is easily tracked and available.

The product exchange process is a way to have the manufacturer, the dealer/outlet, and the consumer participate in a longer term plan in which all benefit throughout the term of the program. Product exchange process is a simple, non confrontational method for people to have, use, and enjoy new product per year that is a fraction of the product's price and taxes and experience choices which may not be affordable otherwise. The advantage of the product exchange program is it allows a customer to have the use of a new product each year for a fee considerably less than the price of the product. Another advantage is the customer eliminates the burden of having to resell the product and distributes the burden back to the sales outlet and or the manufacturer. Another advantage is a second customer buys considerably newer product, avoiding the big cost of depreciation of said product or if offered could begin an exchange program with the returned product. Another advantage is the first customer exchanges product every year and maintains brand new product with current warranty and eliminates expensive repairs.

Example Using a New Automobile

In an example using a new automobile, first customer goes to an outlet which in this example will be an automobile dealer. First customer determines type of auto and options he or she desires. Outlet (2) determines the amount the auto would sell for with the particular options and features. For this example we will use $20,000. Let's say first customer picks a 3 year exchange term. Let's assume that the percent of the selling price for the 3 year program is 40%. This would calculate to $8000 plus applicable taxes and fees. This would be a one time fee for the term of the exchange assuming first customer maintains a $20,000 vehicle each year.

First customer is to carry insurance on the vehicle and is responsible for general maintenance items such as oil changes, etc. Mechanical problems that are not from first customer's neglect are covered under manufacturer's warranty.

Prior to first customer's anniversary date (date on which he took possession of first vehicle), first customer goes to outlet to order the next vehicle for which the customer will exchange his current vehicle. If the next vehicle is the same amount of money, there is no money needed for exchange. If the vehicle being brought back has been damaged beyond normal wear and tear, money is owed whether through insurance or customer. If customer wants to upgrade or choose something more expensive, then the difference between the original value and the new value would be charged at the same percentage rate. (i.e. new value is $23,000 less old value of $20,000 equals $3000. $3000×40% is $1200 due plus applicable taxes and fees on that portion.)

The day each vehicle is picked up, the manufacturer and or outlet can list the vehicle on a community website for sale to a second customer. This database website will provide detailed information about vehicles that will be returned and exchanged. The information is provided with enough time in advance that the second customer can make a good, educated decision about purchasing the vehicle of interest.

Once the vehicle has been returned for exchange, the second customer may purchase the vehicle. Let's assume fair market value of the above vehicle after 1 year is $16,000. This is $4000 less than the original price. The second customer would purchase the vehicle for $16,000 plus applicable taxes on that price. Depending on the length of manufacturer's warranty, the second customer may benefit from the remaining amount of warranty. The second customer benefits from buying the vehicle after the initial depreciation which tends to be highest in the first year of vehicle ownership.

Another option for the second customer, if offered, would be to begin an exchange program with the returned vehicle. Value of the vehicle would be based on the fair market value which is $16,000 in. The exchange program percentages would be the same as the original program as above (3 year is 40%). The second customer would give up the brand new status and the ability to order the vehicle to their preference but, in return would save on the fee because it is figured on the current value of the product avoiding the first year of depreciation. Warranties would be based on the guidelines of the manufacturer.

If the vehicle becomes re-exchanged with the second customer then the manufacturer and-or outlet would market vehicle to sell to a third customer. Re-exchanging could possibly continue with the original product depending on circumstances. If not, the third customer would become the purchaser of the product for fair market value at that time.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

I claim:

1. A method of selling products, comprising:
offering the purchaser of a product a right to enter a product exchange program whereby the product may be returned for exchange for a new product after a predetermined length of time for a predetermined fee;
establishing a product data base for storing sales information on products entered into the product exchange program including the date of return of the product;
offering to sell the used products in the product exchange program over an internet exchange website to a plurality of potential sellers when the products are returned for exchange; and
offering the purchaser of a used product a right to enter a product exchange program whereby the used product may be returned for exchange for a new product after a predetermined length of time for a predetermined fee.

2. A method of selling products as recited in claim 1 wherein a manufacturer offers the purchaser of a product a right to enter a product exchange program.

3. A method of selling products as recited in claim 1 wherein a distribution outlet offers the purchaser of a product a right to enter a product exchange program.

4. A method of selling products as recited in claim 1 wherein the product may be items that depreciate with age and use such as automobiles, boats, recreational vehicles, machinery, equipment, etc.

5. A method of selling products as recited in claim 1 wherein the manufacturer's warranty stays with the product.

6. A method of selling products as recited in claim 1 wherein a manufacturer offers to sell the used products in the product exchange program over an internet exchange website to a plurality of potential sellers when the products are returned for exchange.

7. A method of selling products as recited in claim 1 wherein a distribution outlet offers to sell the used products in the product exchange program over an internet exchange website to a plurality of potential sellers when the products are returned for exchange.
